(19) United States
(12) Patent Application Publication
(10) Pub. No.: US 2002/0184127 A1
(43) Pub. Date: Dec. 5, 2002

(54) New business methods for financial settlement and asset financing across entire supply chains

(76) Inventors: Gianpaolo Callioni, Palo Alto, CA (US); Dorothea T. Kuettner, Mountain View, CA (US)

Correspondence Address: HEWLETT-PACKARD COMPANY, Intellectual Property Administration, P.O. Box 272400, Fort Collins, CO, 80527-2400, US

(21) Appl. No.: 09/873,072

(22) Filed: May 31, 2001

(51) Int. Cl. G06F 17/60

(52) U.S. Cl. 705/35; 705/39

(57) ABSTRACT

A process for expediting financial transactions for supply chains. A financial clearinghouse will be established which will coordinate financial transactions for the supply chain participants. The clearinghouse can be a company, financial institution (s), partnership, or any individual (s) willing to play the role of clearinghouse. The clearinghouse will act in concert with supply chain participants to coordinate and expedite the financial, material, logistic, and information flow. The financial support provided by the clearinghouse will include payments and credits for supply chain participants. These payments and credits will be used for logistics, materials, and value-added services performed.

### FIELD OF THE INVENTION

The present invention is a business process which will use a supply chain clearinghouse to coordinate and expedite the flow of goods and finances throughout the entire supply chain.

### BACKGROUND OF THE INVENTION

In the present manufacturing process, a product passes through a supply chain as it is converted from raw materials into a finished product and ultimately delivered to the end user. Currently, the supply chain system treats transactions between nodes in the supply chain as a series of separate events rather than parts of a larger whole. This results in a system that is not optimized for financial efficiency.

Previously, some companies would employ a vertically integrated business model. In this model, the manufacturer would own all raw materials and components involved in the manufacture of a product. The company would own and control every process at each step in the manufacturing process. Referring to FIG. 1, corporation 100 owns automobile company 104, tire factory 103, rubber factory 102, and rubber plantation 101 to manufacture tires for its automobiles. The rubber was harvested at the rubber plantation 101, and processed at rubber factory 102. The rubber was sent to tire factory 103 to create a tire which was sent to automobile manufacturer 104. This system proved to be inefficient as more specialized manufacturers created the same components, in this case tires, at a lower price due to economies of scale. By being able to choose from a number of tire suppliers, the company could get a lower price through competitive pricing.

Most companies now use a vertically integrated business model, buying components from various manufacturers at the lowest price and assembling them to create the final product. This model is inherently inefficient as it does not coordinate the flow of materials, information, and finances in the supply chain as a whole.

Referring to FIG. 2, each node of the supply chain is separately responsible for processing purchase orders, acknowledgments, billing for purchases and value-added services, proof of delivery, accounts receivable, accounts payable, credits, and logistics services. Having each participant in the supply chain separately responsible increases administrative costs for the entire supply chain. Additionally, at each step in the process there are further delays as each transaction is cleared separately through the financial institutions. As the product moves down the supply chain, the processing lag increases due to potential financial constraints of participating supply chain parties or their payment practices. Financial flow is characterized by a series of starts and stops as each transaction is completed separately. Because of these uncertainties in the cash flow, net working capital requirements are higher than would otherwise be necessary.

The present system is also not responsive enough in allowing small suppliers to receive large orders. Products at the most upstream node of the supply chain generally have a low value attached to them. An example would be a plastics manufacturer that makes computer cases. To the financial institution, the value of that manufacturers inventory is relatively low as it is based on the value of the plastic cases alone. To the computer manufacturer, the value of the cases is relatively greater as the plastic case is considered integral to the final product. These suppliers often have difficulty securing credit because the value of their product is low. If there is a large order placed by the end user, these suppliers may need a loan to cover the initial costs of materials to fulfill the order. They may not be able to secure a loan due to the lower line of credit, or be forced to accept a higher interest rate due to the increased risk the financial institution is taking on in extending their credit. Because the financial institution does not see the supply chain as a whole, it undervalues the components of the supply chain.

In the present system, manufacturers must endure the inefficiencies in financial flow cited, in order to enjoy the advantages of working with multiple supply partners. What is needed is a single process that will reduce the overhead associated with numerous participants in the supply chain. Additionally, there is a need to base financial decisions on the supply chain as a whole, rather than on the individual components. The present invention provides a novel solution to the above needs.

### SUMMARY OF THE INVENTION

The present invention creates a process which will reduce the overhead associated with numerous participants in a supply chain. It will provide financing for the supply chain as a whole, and coordinate supply chain transactions. It will allow manufacturers to enjoy the advantages of working with multiple supply chain partners while reducing the financial inefficiencies.

This process will establish a clearinghouse for financial transactions along the supply chain. The clearinghouse can be a company, financial institution (s), partnership, or any individual (s) willing to play the role of clearinghouse. The clearinghouse will act in concert with supply chain participants to coordinate and expedite the financial, material, logistic, and information flow. Manufacturers will be able to enjoy the advantages of working with different partners and reduce the inefficiencies in the present system of financial flow.

In one embodiment, the clearinghouse finances the goods from the most upstream node of the supply chain and remains the owner until the goods are sold to supply chain participants or the end user. The clearinghouse pays the most upstream node of the chain the full material costs. All subsequent nodes in the supply chain are paid for value-added costs or logistic services. The clearinghouse would also coordinate and expedite all of the basic commercial transactions such as purchase orders, acknowledgments, electronic billing for material purchases and logistic services, credits, and proof of delivery. The clearinghouse clears the accounts according to terms and conditions negotiated between the clearinghouse and the participating supply chain parties, comparing net receivables to net payables, and pays out the difference to supply chain participants. Referring to FIG. 3, it can be seen that the transactions across the entire supply chain will be reconciled with fewer delays with one entity clearing accounts rather than having each of the supply chain participants acting separately. The transactions can be triggered automatically through defined events such as a pre-determined time period, proof of delivery, or electronic bill presentment. In another embodiment of this invention, credit is extended without retaining ownership until the product reaches final assembly in the supply chain.

Another embodiment of this process would allow ownership to change throughout the supply chain. In this embodiment, ownership is transferred to supply chain participants as the product moves along the supply chain. The clearinghouse pays and is paid by all supply chain participants as ownership is transferred. Payments to supply chain participants would go into restricted accounts that would only use the funds in these accounts to pay for material purchases or logistics services. This would prevent participants from using funds intended for materials or logistic services for other accounting purposes. Only value-added services would be paid without restrictions to supply chain participants.

The advantages of the present invention will no doubt become obvious to those of ordinary skill in the art after having read the following detailed description of the preferred embodiments which are illustrated in the various figure drawings.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 illustrates the prior art vertically integrated business model where a manufacturer owned all entities in the supply chain.

FIG. 2 illustrates the flow of information, material, and finances in the supply chain.

FIG. 3 illustrates a sample spreadsheet comparing how a series of transactions between a manufacturer, sub-assembly contractor, and supplier are paid under the present system, and under the proposed business method.

FIG. 4 illustrates an exemplary computer system that can be used with the embodiment of the present invention.

FIG. 5 illustrates an exemplary computer network that can be used with the embodiment of the present invention.

FIG. 6 shows an embodiment of the proposed supply chain clearinghouse.

FIG. 7 shows an embodiment of the restricted account model variation of the proposed clearinghouse with the clearinghouse paying or being paid by participants as the product moves through the supply chain.

FIG. 8 is a flowchart of the steps in the supply chain in accordance with one embodiment of the present invention.

FIG. 9 is a flowchart of the steps in the supply chain in accordance with an alternative embodiment of the present invention.

FIG. 10 is a flowchart of the steps in the supply chain in accordance with an alternative embodiment of the present invention.

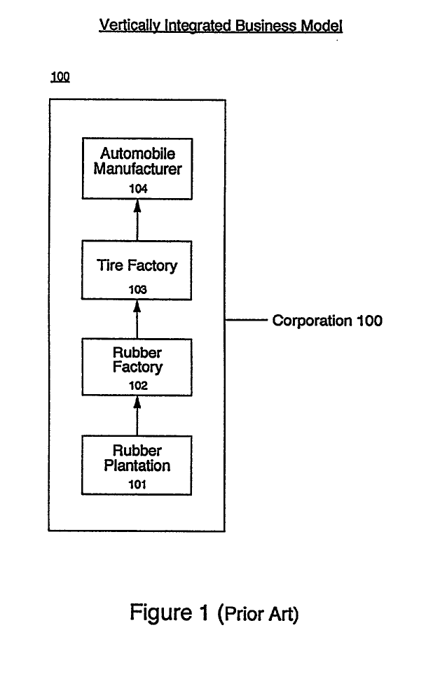

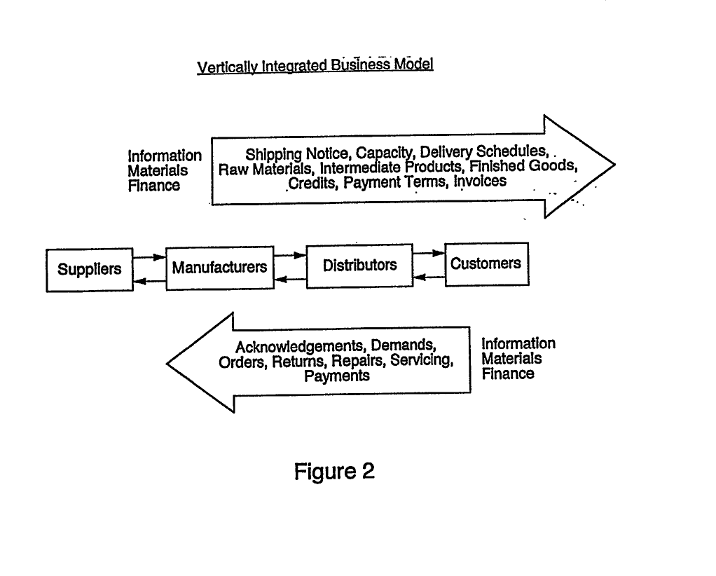

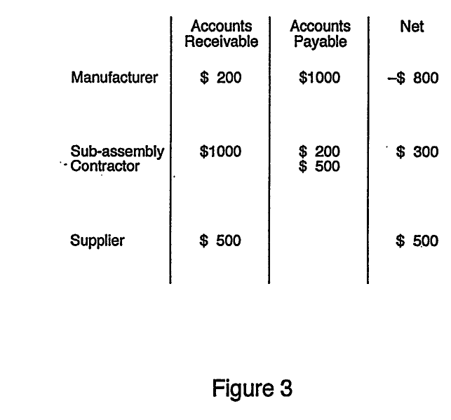

### DETAILED DESCRIPTION

Reference will now be made to the preferred embodiments of the invention, examples of which are illustrated in the accompanying drawings. While the invention will be described in conjunction with the preferred embodiment, it will be understood that it is not intended to limit the invention to this particular embodiment alone. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

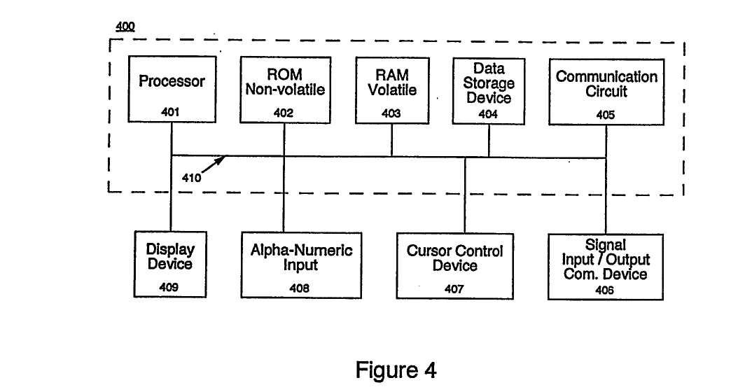

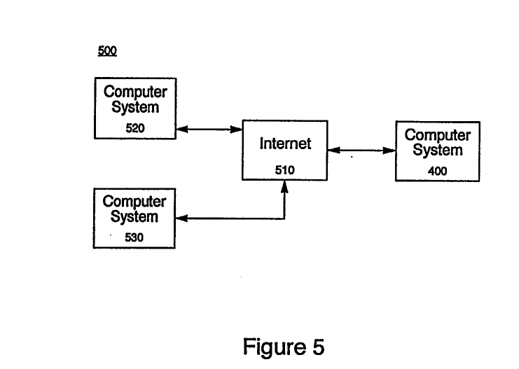

FIG. 4 illustrates an exemplary computer system 400 upon which embodiments of the present invention may be implemented. FIG. 4 is exemplary only; the present invention can operate within a number of different computer systems including general purpose networked computer systems, laptop computer systems, and hand held computer systems. FIG. 5 shows one such computer network in which computer system 400 is a component. Computer system 400 may be one of a plurality of computer systems coupled in a communications network. Computer system 400 is well adapted to having computer readable media such as, for example, a floppy disk, a compact disc, and the like coupled thereto. Such computer readable media is not shown coupled to computer system 400 in FIG. 4 for purposes of clarity.

System 400 of FIG. 4 includes a central processor unit 401 for processing information and instructions coupled to an address/data bus 410 for communicating information and instructions. System 400 also includes read only memory (ROM) 402, coupled to bus 410 for storing static information and instructions for the central processor unit 401, computer usable volatile memory (RAM) 403, coupled to bus 410 for storing information and instructions for central processor unit 401, data storage device 404 (e.g., a magnetic or optical disk and disk drive), coupled to bus 410 for storing information and instructions, and communication circuit 405, coupled to bus 410 to enable system 400 to communicate in a general purpose networked computer system such as system 500. System 400 also includes a signal input/output communications device 406, coupled to bus 410 to facilitate communications in a general purpose networked computer system, a cursor control device 407, coupled to bus 410 for communicating user input information and command selections to central processor unit 401, an optional alpha-numeric input 408, coupled to bus 410 for communicating information and command selections to central processor unit 401, and an optional display device 409, coupled to bus 410 for displaying information.

Referring still to FIG. 4, optional display device 409 of FIG. 4, may be a liquid crystal device, cathode ray tube, or other display device suitable for creating graphic images and alpha-numeric characters recognizable to a user. Optional cursor control device 407 allows the computer user to dynamically signal the two dimensional movement of a visible symbol (cursor) on a display screen of display device 409. Many implementations of cursor control device 407 are known in the art including a trackball, mouse, touch pad, joystick or special keys on alpha-numeric input 408 capable of signaling movement of a given direction or manner of displacement. Alternatively, it will be appreciated that a cursor can be directed and/or activated via input from alpha-numeric input 408 using special keys and key sequence commands. Alternatively, the cursor may be directed and/or activated via input from a number of specially adapted cursor directing devices.

In accordance with the present embodiment of the present invention, computer system 400 executes software elements such as an operating system, device drivers, application programs (“applications”) including computer software programs, word processors, database management systems, accounting programs, electronic mail, and communication programs that execute communication protocols that define the procedures to be followed when data are transmitted and received.

FIG. 5 illustrates an exemplary computer network 500 upon which embodiments of the present invention may be implemented. FIG. 5 is exemplary only; the present invention can operate within a number of different computer systems including general purpose networked computer systems, laptop computer systems, and hand held computer systems. FIG. 5 shows one such computer network which consists of Internet 510, computer system 520, computer system 530, and computer system 400. The computer systems 520, 530, and 400 may be in physically separate locations (e.g., remotely separated from each other), each computer system running the accounting software necessary for the financial settlement and asset financing of the present invention. It is appreciated that the present invention can be utilized with any number of computer systems.

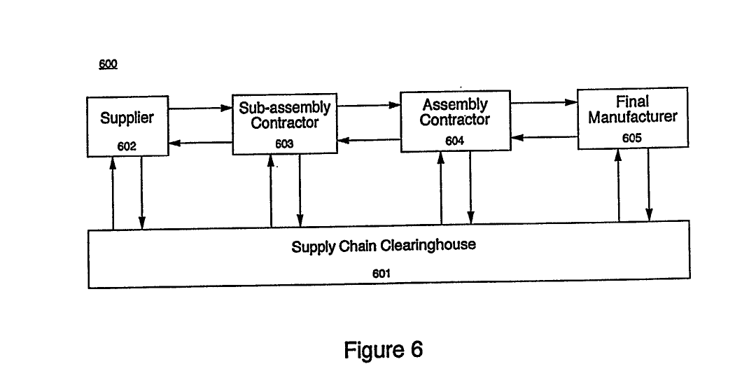

FIG. 6 shows the supply chain clearinghouse 601 upon which embodiments of the present invention may be implemented. Exemplary supply chain model 600 comprises supply chain clearinghouse 601, supplier 602, sub-assembly contractor 603, assembly contractor 604, and final manufacturer 605. Supply chain clearinghouse 601 may be any individual (s), company (s), or institution (s) willing to fulfill the role. It should be noted that the supply chain in the present embodiment does not necessarily end with the final manufacturer. It may be extended to include product distribution and sales to customers. These supply chain participants were omitted for clarity.

Final manufacturer 605 places an order for components it will require from assembly contractor 604 with supply chain clearinghouse 601. Supply chain clearinghouse 601 forwards the order for parts to assembly contractor 604. Assembly contractor 604 presents a bill to supply chain clearinghouse 601 for the cost of value-added services rendered and any logistical debts incurred. Alternatively, the logistics provider, if different than assembly contractor 604, could bill the clearinghouse directly. Logistics debts comprise the cost of shipping and storage of materials. Assembly contractor 604 places an order for parts it will require from sub-assembly contractor 603 with supply chain clearinghouse 601. Supply chain clearinghouse 601 forwards the order for parts to sub-assembly contractor 603. Sub-assembly contractor 603 presents a bill to supply chain clearinghouse 601 for the cost of value-added services rendered and any logistical debts incurred. Sub-assembly contractor 603 places an order for supplies it will require from supplier 602 with supply chain clearinghouse 601. Supply chain clearinghouse 601 forwards the order for supplies to supplier 602. Supplier 602 presents a bill to clearinghouse 601 for the value of the supplies it will provided and any logistic debts incurred. At an interval determined by the terms and conditions agreed to between supply chain clearinghouse 601 and supply chain participants, all accounts are netted and funding is electronically transferred between accounts as needed. At this point, supply chain clearinghouse 601 is the owner of the materials as they pass through the supply chain. Alternatively, clearinghouse 601 bills final manufacturer 605 for the materials plus all incurred value-added activities and logistics costs.

In another embodiment of the proposed business model, final manufacturer 605 contacts assembly contractor 604 with an order for a given number of components it will require. Assembly contractor 604 bills the account of supply chain clearinghouse 601 for value-added services to be performed by assembly contractor 604 and any logistical debts incurred. Assembly contractor 604 then contacts sub-assembly contractor 603 with an order for a given number of parts to fulfill the order given by final manufacturer 605. Sub-assembly contractor 603 bills the account of the supply chain clearinghouse 601 for value-added services to be performed by sub-assembly contractor 603 and any logistical debts incurred. Sub-assembly contractor 603 contacts supplier 602 for supplies to fulfill the order given by assembly contractor 604. Supplier 602 bills the account of the supply chain clearinghouse 601 for the cost of supplies ordered by sub-assembly contractor 603 and any logistical debts incurred. At an interval determined by the terms and conditions agreed to between supply chain clearinghouse 601 and the supply chain participants, all accounts are netted and funding is electronically transferred between accounts as needed. Supply chain clearinghouse 601 now owns the materials and can pass them along the supply chain up to distribution and final sale to the customer. Alternatively, clearinghouse 601 bills the manufacturer for materials, value-added services, and logistics costs. The manufacturers now own the materials and can pass them along the supply chain up to distribution and final sale to customers.

In yet another embodiment of the current invention, the clearinghouse will extend credit to participants in the supply chain without retaining ownership until some later stage in the supply chain. Referring again to FIG. 6, final manufacturer 605 places an order with supply chain clearinghouse 601 for a given number of components required in its manufacturing process. The manufacturers will have the option of accessing their own credit if it serves their best interests, or can request credit from the supply chain clearinghouse for the cost of components, value-added services to be performed, and logistic costs. Supply chain clearinghouse 601 extends credit to final manufacturer 605 for these costs, and forwards the order to assembly contractor 604. Assembly contractor 604 places an order for required parts and requests credit from supply chain clearinghouse for the cost of parts, value-added services to be performed, and logistics costs. Supply chain clearinghouse 601 extends credit to assembly contractor 604 for these costs, and forwards the order for parts to sub-assembly contractor 603. Sub-assembly contractor 603 places an order for required supplies and requests credit from supply chain clearinghouse for the cost of supplies, value-added services to be performed, and logistics costs. Supply chain clearinghouse 601 extends credit to sub-assembly contractor 603 for these costs, and forwards the order for supplies to supplier 602.

As the supplies are shipped to sub-assembly contractor 603, supplier 602 bills sub-assembly contractor 603 for the value of the supplies and any logistic costs. Sub-assembly contractor 603 pays supplier directly from the funds credited by supply chain clearinghouse 601. As the parts are shipped to assembly contractor 604, sub-assembly contractor 603 bills assembly contractor 604 for the cost of supplies, value-added services, and logistic debts incurred. Assembly contractor 604 pays sub-assembly contractor 603 directly from funds credited by supply chain clearinghouse 601. As the components are shipped to final manufacturer 605, sub-assembly contractor 604 bill final manufacturer 605 for value-added services, parts, and logistics. Final manufacturer 605 pays assembly contractor 604 directly from funds credited by supply chain clearinghouse 601. When final manufacturer 605 completes its manufacturing process, ownership of the materials is transferred to supply chain clearinghouse, because the costs of components, value-added services, and logistics have been previously credited. If the manufacturer did not use the credit from the supply chain clearinghouse, they retain ownership of the materials until paid by the next participant in the supply chain.

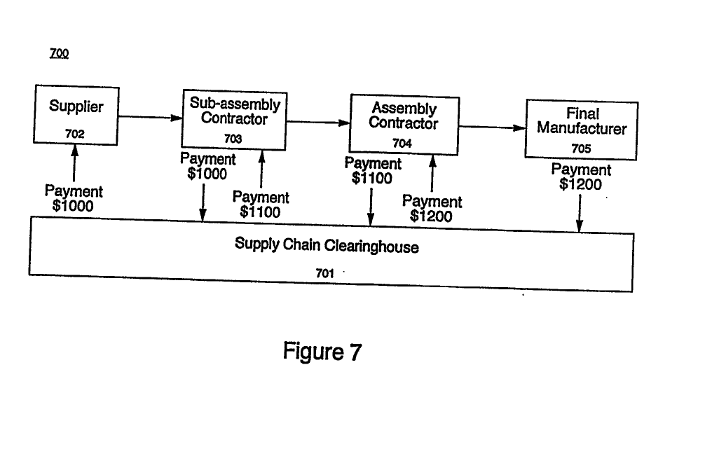

FIG. 7 shows an alternative embodiment of the proposed business method. Supply chain 700 comprises of supply chain clearinghouse 701, supplier 702, sub-assembly contractor 703, assembly contractor 704, and final manufacturer 705. Again, the supply chain does not necessarily end with the final manufacturer, but was omitted for clarity. Additional participants in the supply chain were omitted for clarity. Final manufacturer 705 contacts assembly contractor 704 with an order for a given number of components. Assembly contractor 704 contacts sub-assembly contractor 703 for a given number of parts to fulfill the order of final manufacturer 705. Sub-assembly contractor 703 contacts supplier 702 for supplies to fulfill the order of assembly contractor 704. When the supplies are sent to sub-assembly contractor 703, supplier 702 bills supply chain clearinghouse 701 for the cost of the supplies and any logistics debts incurred. Funds are transferred to the account of supplier 702 from the general fund account of supply chain clearinghouse 701. The payments for logistics will go to a restricted account which can only be used by supplier 702 to pay for logistics costs. This is to prevent sub-assembly contractor 702 from using funds intended for logistics costs for other accounting purposes. At this point, supply chain clearinghouse 701 retains ownership of the supplies.

Still referring to FIG. 7, when the supplies are received at sub-assembly contractor 703, funds are transferred from the account of sub-assembly contractor 703 to the general fund account of supply chain clearinghouse 701 for the cost of the supplies, at which time sub-assembly contractor retains ownership of the supplies. When sub-assembly contractor 703 sends the parts to assembly contractor 704, a bill is presented to supply chain clearinghouse 701 for the cost of value-added services rendered, material costs, and any logistics debts incurred. All payments are made according to the terms and conditions negotiated between supply chain clearinghouse 701 and the supply chain participants. The materials and logistics payments will again go to a restricted account which can only be used by sub-assembly contractor 703 to pay for the materials and logistics costs. The cost of value-added services will be paid to sub-assembly contractor 703 without restrictions. At this point, supply chain clearinghouse 701 again retains ownership of the parts. When the parts are received at assembly contractor 704, funds are transferred from the account of assembly contractor 704 to the general fund account of supply chain clearinghouse 701 for the cost of the parts. At this point, assembly contractor 704 retains ownership of the parts. When assembly contractor 704 sends the parts to final manufacturer 705, a bill is presented by assembly contractor 704 to supply chain clearinghouse 701 for the cost of value-added services rendered, material costs, and logistics debts incurred. Again, the materials and logistics payments will go to a restricted account which can only be used by assembly contractor 704 to pay for the materials and logistics costs. When the components are received at final manufacturer 705, funds are transferred from the account of final manufacturer 705 to the general fund account of supply chain clearinghouse 701 for the cost of the components. At this point, final manufacturer 705 retains ownership of the final product. This process can continue up the distribution chain until the product is sold to the consumer.

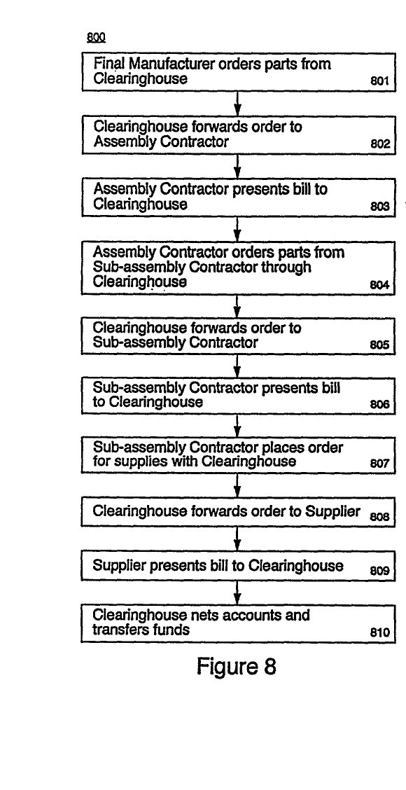

FIG. 8 is a flowchart of process 800 for communicating orders and financial information in the supply chain in accordance with one embodiment of the present invention. In step 801 of FIG. 8, with reference also to FIG. 6, final manufacturer 605 orders components through supply chain clearinghouse 601. In step 802, supply chain clearinghouse 601 forwards the order for components to assembly contractor 604. In step 803, assembly contractor 604 presents a bill to supply chain clearinghouse 601 for the cost of value-added services to be performed and logistics debts incurred. In step 804, assembly contractor 604 orders parts through supply chain clearinghouse 601. In step 805, supply chain clearinghouse 601 forwards the order for parts to sub-assembly contractor 603 In step 806, sub-assembly contractor 603 presents a bill to supply chain clearinghouse 601 for the cost of value-added services to be performed and logistics debts incurred. In step 807, sub-assembly contractor 603 orders supplies through supply chain clearinghouse 601 from supplier 602. In step 808, supply chain clearinghouse 601 forwards the order for supplies to supplier 602. In step 809, supplier 602 presents a bill to supply chain clearinghouse 601 for the cost of materials to be supplied and any logistics debts incurred. In step 810, supply chain clearinghouse 601 nets the accounts of all participants and transfers funds as appropriate.

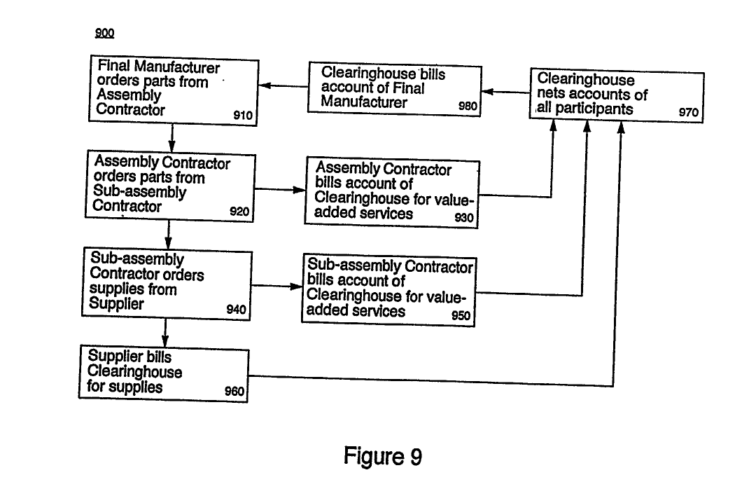

FIG. 9 is a flowchart of process 900 for communicating orders and financial information in the supply chain in accordance with one embodiment of the present invention. In step 910 of FIG. 9, with reference also to FIG. 6, final manufacturer 605 orders parts from assembly contractor 604. In step 920, assembly contractor 604 orders parts from sub-assembly contractor 603. In step 930, assembly contractor 604 bills the account of supply chain clearinghouse 601 for the value-added services it will perform and logistics debts incurred. In step 940, sub-assembly contractor 603 orders supplies from supplier 602. In step 950, sub-assembly contractor 603 bills the account of supply chain clearinghouse 601 for the value-added services it will perform and logistics debts incurred. In step 960, supplier 602 bills the account of supply chain clearinghouse 601 for the value of the supplies it provides to sub-assembly contractor 603 and any logistics debts incurred. In step 970, supply chain clearinghouse 601 nets the accounts of all supply chain participants according to its terms and conditions. In step 980, supply chain clearinghouse 601 bills the account of final manufacturer 605.

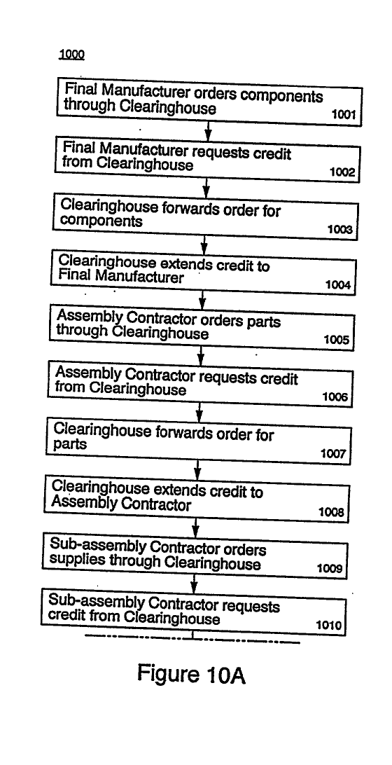

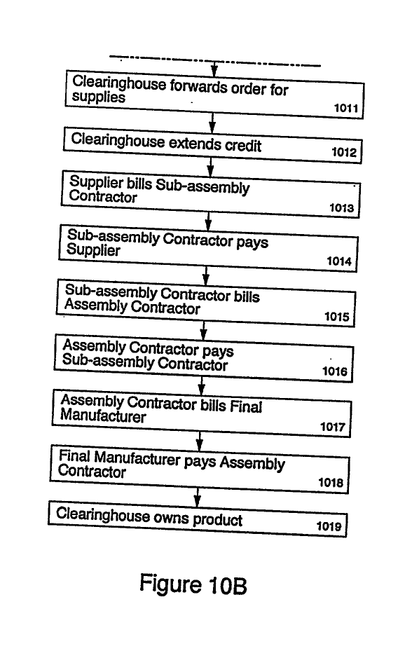

FIG. 10 is a flowchart of process 1000 for communicating orders and financial information in the supply chain in accordance with one embodiment of the present invention. In step 1001 of FIG. 10, with reference also to FIG. 6, final manufacturer 605 orders components through clearinghouse 601. In step 1002, final manufacturer 605 requests credit from clearinghouse 601. In step 1003, clearinghouse 601 forwards the order for components. In step 1004, clearinghouse 601 extends credit to final manufacturer 605. In step 1005, assembly contractor 604 orders parts through clearinghouse 601. In step 1006, assembly contractor 604 requests credit from clearinghouse 601. In step 1007, clearinghouse 601 forwards the order for parts to sub-assembly contractor 603. In step 1008, clearinghouse 601 extends credit to assembly contractor 604. In step 1009, sub-assembly contractor 603 orders supplies through clearinghouse 601. In step 1010, sub-assembly contractor 603 requests credit from clearinghouse 601. In step 1011, clearinghouse 601 forwards the order for supplies to supplier 602. In step 1012, clearinghouse 601 extends credit to sub-assembly contractor 603. In step 1013, supplier 602 bills sub-assembly contractor 603. In step 1014, sub-assembly contractor 603 pays supplier 602. In step 1015, sub-assembly contractor 603 bills assembly contractor 604. In step 1016, assembly contractor 604 pays sub-assembly contractor 603. In step 1017, assembly contractor 604 bill final manufacturer 605. In step 1018, final manufacturer 605 pays assembly contractor 604. In step 1019, clearinghouse 601 now owns the product.

While the present invention has been described in particular embodiments, it should be appreciated that the present invention should not be construed as limited by such embodiments, but rather construed according to the following claims.

What is claimed is:

1. A process for providing a financial clearinghouse for a supply chain comprising the steps of:
a) defining a plurality of business units comprising the supply chain;
b) providing financing by the clearinghouse for at least one business unit wherein the supply chain is a factor in determining the degree of financing for the business unit; and
c) coordinating supply chain transactions by the financial clearinghouse between the plurality of the business units.

2. The process of claim 1, wherein the supply chain transactions comprises the flow of financial assets.

3. The process of claim 2, wherein the flow of financial assets comprises payments for value-added services.

4. The process of claim 2, wherein the flow of financial assets comprises payments for materials.

5. The process of claim 2, wherein the flow of financial assets comprises payments for logistic services.

6. The process of claim 2, wherein the flow of financial assets comprises credits for value-added services.

7. The process of claim 2, wherein the flow of financial assets comprises credits for materials.

8. The process of claim 2, wherein the flow of financial assets comprises credits for logistic services.

9. The process of claim 1, wherein the supply chain transactions comprises the transfer of materials.

10. The process of claim 9, wherein the transfer of materials comprises the transfer of raw materials.

11. The process of claim 9, wherein the transfer of materials comprises the transfer of parts and components.

12. The process of claim 9, wherein the transfer of materials comprises the transfer of finished products.

13. The process of claim 1, wherein the supply chain transactions comprises logistic services.

14. The process of claim 13, wherein the logistic services comprises transportation of materials, further including transactions arising from import and export activities.

15. The process of claim 13, wherein the logistic services comprises storage of materials.

16. The process of claim 1, wherein the supply chain transactions comprises the exchange of information.

17. A computer system comprising:
a bus;
a memory unit coupled to the bus; and
a processor coupled to the bus, said processor for executing a process for providing a financial clearinghouse for supply chains comprising the steps of:
a) defining a plurality of business units comprising the supply chain,
b) providing financing by the clearinghouse for at least one business unit wherein the supply chain is a factor in determining the degree of financing for the business unit; and
c) coordinating supply chain transactions by the financial clearinghouse between the plurality of the business units.

18. The computer system of claim 17 wherein the supply chain transactions comprises at least one of the following:
payments for value-added services, payments for materials, payments for logistic services, credits for value-added services, credits for materials, credits for logistic services, transfer of raw materials, transfer of parts and components, transfer of finished products, transportation of materials, storage of materials, and the exchange of information.

19. A computer-usable medium having computer-readable program code embodied therein for causing a computer system to perform the steps of:
a) defining a plurality of business units comprising the supply chain,
b) providing financing by the clearinghouse for at least one business unit wherein the supply chain is a factor in determining the degree of financing for the business unit, and
c) coordinating supply chain transactions by the financial clearinghouse between the plurality of the business units.

20. The computer-usable medium of claim 19 wherein the supply chain transactions comprises at least one of the following:
payments for value-added services, payments for materials, payments for logistic services, credits for value-added services, credits for materials, credits for logistic services, transfer of raw materials, transfer of parts and components, transfer of finished products, transportation of materials, storage of materials, and the exchange of information.
